(19) United States
(12) Patent Application Publication
(10) Pub. No.: US 2023/0349441 A1
(43) Pub. Date: Nov. 2, 2023

(54) INTERNAL SNAPPING GAITER

(71) Applicant: Continental Automotive Systems, Inc., Auburn Hills, MI (US)

(72) Inventors: Joseph G Jerisk, Burton, MI (US); Garrett Mark Pniewski, Bloomfield Hills, MI (US)

(73) Assignee: Continental Automotive Systems, Inc., Auburn Hills, MI (US)

(21) Appl. No.: 17/661,620

(22) Filed: May 2, 2022

(51) Int. Cl. F16F 9/36

(52) U.S. Cl. CPC F16F 9/361

(57) ABSTRACT

An air spring assembly including an internal snapping gaiter. The internal snapping gaiter includes a free end having a flange that is snap fit to a retainment tab of a free end of a guide tube of the air spring assembly.

### BACKGROUND

### 1. Field

The present application relates to a chassis and air suspension of a motor vehicle, and more particularly to an air sprig gaiter.

### 2. Description of Related Art

Suspension systems for automotive vehicles provide vehicle passengers with a more comfortable ride. Air suspension systems utilize air springs, rather than traditional coil springs, and provide different suspension qualities that may be preferable in some vehicles to traditional coil spring suspensions.

A conventional air spring is a device that is arranged between a vehicle body and chassis. The typical air spring has at least one working space or cavity that is filled with compressed air. Space constraints can limit the amount of working space for the air spring assembly, especially as vehicles are designed with increasingly tighter space constraints.

One component of an air spring is a gaiter, which provides protection to components of the air spring including a piston and damper. The gaiter may be configured as a sawtooth gaiter with or without special folds, a rubber/EPDM material that folds in reverse of the air spring bellow, a stretchy elastic gaiter, and multiple corrugated gaiters working in conjunction.

Conventionally, manual assembly of gaiters for guided air springs is necessary. In one example, the addition of an Oetiker clamp is required to secure the gaiter to the guide tube.

FIG. 1 is a diagram of a conventional air spring assembly. As illustrated in FIG. 1, the air spring assembly 100 includes a guide tube 110, a gaiter 120, and a fastener 130. The fastener 130 may be an Oetiker clamp, zip tie, or other fastening means for securing the gaiter 120 to the guide tube 110. The air spring assembly 100 of FIG. 1 may be manually assembled through sliding an inner diameter of the gaiter 120 over an outer diameter of the guide tube 110. Once the gaiter 120 is overlapped with the guide tube 110, then the fastener 130 may be tightened in the air of overlap between the gaiter 120 and the guide tube 110. As a result, the connection between the guide tube 110 and the gaiter 120 may be manually secured through means of the fastener 130.

Accordingly, there exists a need for an air spring assembly having a gaiter suitable for ease of installation and reduced total compressed height, and thus an improved gaiter for the air spring.

### SUMMARY

Aspects of embodiments of the present application relate to an air spring gaiter with a reduced upper diameter to easily permit machine assembly and retainment.

According to aspects of the embodiments, a primary function of the gaiter design enables a lead on an upper side of the gaiter to snap into an inner diameter flange on a guide tube. Upon securing the gaiter to the guide tube, the structure of the air spring assembly is securely retained when the air spring is stroked in either an upwards direction or a downwards direction. Therefore, automated operation for assembly may be provided, while still retaining a primary function of the gaiter as a debris shield for the bellow of the air spring assembly.

According to an aspect of an embodiment, there is provided an air spring assembly including a guide tube, the guide tube comprising a retainment tab disposed at a free end of the guide tube, a gaiter, the gaiter comprising a flange disposed at a free end of the gaiter, wherein the retainment tab is configured to be disposed within the flange to couple the guide tube and the gaiter.

### BRIEF DESCRIPTION OF THE DRAWINGS

The above and other aspects will be more clearly understood from the following brief description taken in conjunction with the accompanying drawings, in which:

FIG. 1 is a diagram of a conventional air spring assembly; and

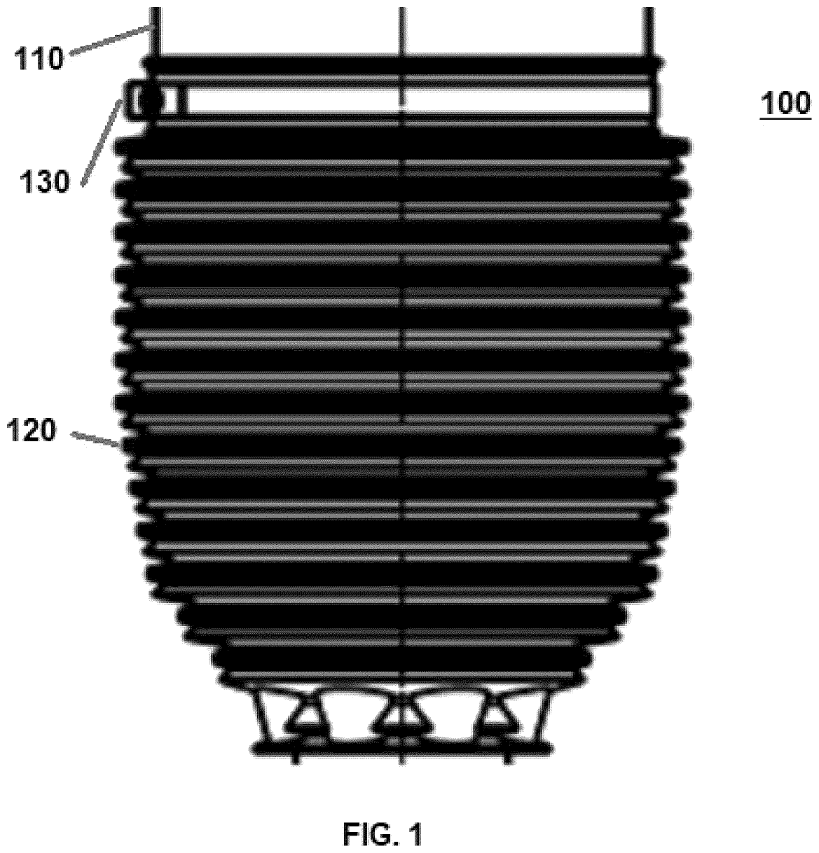

FIG. 2 is a diagram of an air spring assembly, according to an embodiment.

### DETAILED DESCRIPTION

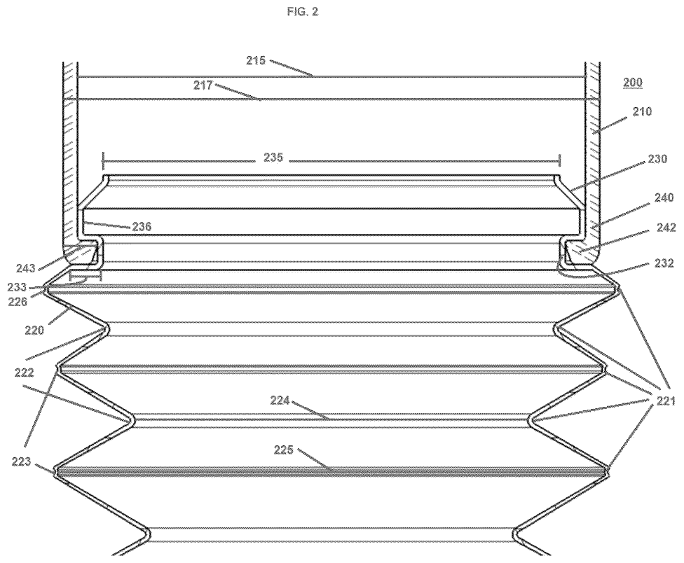

FIG. 2 is a diagram of an air spring assembly, according to an embodiment.

As illustrated in FIG. 2, the air spring assembly 200 includes a guide tube 210 and a gaiter 220.

The guide tube 210 may have an inner diameter 215 and an outer diameter 217. Accordingly, a thickness of the guide tube may be a difference between the inner diameter 215 and the outer diameter 217.

The gaiter may include a plurality of folds 221. The plurality of folds may include a plurality of concave folds 222 and a plurality of convex folds 223. Each concave fold among the plurality of concave folds 222 may be alternatingly coupled to a convex fold among the plurality of convex folds 223.

The gaiter 220 may have a first diameter 224. The first diameter 224 may be a distance between opposing concave folds among the plurality of concave folds 222. The first diameter 224 of the gaiter 220 may be referred to as an inner diameter of the gaiter 220. The first diameter 224 of the gaiter 220 may be less than the inner diameter 215 of the guide tube 210.

The gaiter may also have a second diameter 225. The second diameter 225 may be a distance between opposing convex folds among the plurality of convex folds 225. The second diameter 225 of the gaiter 220 may be referred to as an outer diameter of the gaiter 220. The second diameter 225 of the gaiter may be greater than the outer diameter 217 of the guide tube 210.

The gaiter 220 includes a free end 230. The free end 230 of the gaiter 220 may be a referred to as a distal end or terminating end of the gaiter 220. A diameter 235 of the free end 230 of the gaiter 220 may be less than the inner diameter 215 of the guide tube 210. Moreover, as will be described later, the diameter 235 of the free end 230 of the gaiter may be less than a diameter of the guide tube 210 and retainment tab 242. As a result of the diameter 235 of the free end 230 of the gaiter 220 being less than the diameter 215 of the guide tube 210, an automated, machine press fitting of the guide tube 210 and the gaiter 220 may be performed.

The guide tube 210 may include a free end 240. The free end 240 of the guide tube 210 may be a referred to as a distal end or terminating end of the guide tube 210. The free end 240 of the guide tube 210 may include a retainment tab 242. The retainment tab 242 may be a portion of the guide tube 210 disposed inwardly towards the inner surface of the guide tube. The retainment tab 242 may be formed to have an angle of approximately 90 degrees from a longitudinal direction of a longitudinal wall of the guide tube 210. A width 243 of the retainment tab 242 may be greater than the thickness of the guide tube 210 between the inner diameter 215 of the guide tube and the outer diameter 217 of the guide tube 210.

The free end 230 of the gaiter 220 may be coupled to a terminal convex fold 226 among the plurality of convex folds 223. The free end 230 of the gaiter 220 may include a flange 232 or recess. The flange 232 may extend inwardly from the convex fold 226 to have an angle of approximately 90 degrees from a longitudinal direction of a longitudinal wall of the guide tube 210. Accordingly, the retainment tab 242 and the flange 232 may both extend inwardly towards a center of the guide tube 210 and the air spring assembly 200 at an angle of approximately 90 degrees from a longitudinal direction of a longitudinal wall of the guide tube 210. As a result, the guide tube 210 may not extend downwardly along the gaiter 220 beyond the flange 232 when press fit to the gaiter 220.

A width 233 of the flange 232 coupled to the convex fold 226 may be substantially equal to the width 243 of the retainment tab 240. Accordingly, a size and shape of the retainment tab 240 may correspond to a size and shape of the flange 232, and the retainment tab 240 may be configured to abut the flange 232 when the retainment tab 242 is disposed within the flange 232. As a result, retainment tab 242 of the free end 240 guide tube 210 may be snap fit to the flange 232 of the free end 230 of the gaiter 220.

As opposed to a convex fold similar to the plurality of convex folds 223, the free end 230 of the gaiter 220 may include a vertical portion 236 coupled to the flange 232. A diameter of the free end 230 of the gaiter 220 at the location of the vertical portion 236 may be substantially equal to the inner diameter 215 of the guide tube. Accordingly, the vertical portion 236 of the free end 230 of the gaiter 220 may be configured to abut an inner surface of the guide tube 210 having the inner diameter 215.

Consequently, the structure of the air spring assembly according to embodiments of the present application obviates the need for the manual assembly of the gaiter and outer guide tube. Further, the structure of the air spring assembly according to embodiments of the present application reduces overall cost through omission of additional fasteners required to secure the gaiter and guide tube. Moreover, a compact air spring assembly may be achieved by reducing package space for the gaiter under the guide tube.

1. An air spring assembly comprising:
a guide tube, the guide tube comprising a retainment tab disposed at a free end of the guide tube, wherein the retainment tab extends around an entire circumference of the guide tube; and
a gaiter, the gaiter comprising a flange disposed at a free end of the gaiter, wherein the flange extends around an entire circumference of the gaiter;
wherein the retainment tab is configured to be disposed within the flange to couple the guide tube and the gaiter.

2. The air spring assembly according to claim 1, wherein a diameter of the free end of the gaiter is less than a diameter of the guide tube at the flange.

3. The air spring assembly according to claim 1, wherein the retainment tab is disposed at approximately a 90 degree angle inwardly from a longitudinal wall of the guide tube towards a center of the guide tube.

4. The air spring assembly according to claim 1, wherein the flange comprises a recess in the gaiter, and
wherein a shape of the recess corresponds to a shape of the retainment tab.

5. The air spring assembly according to claim 1, wherein the gaiter comprises a plurality of folds, and
wherein the flange is disposed coupled to a convex fold among the plurality of folds.

6. The air spring assembly according to claim 5, wherein the plurality of folds are concentrically and longitudinally arranged about a longitudinal access of the gaiter

7. The air spring assembly according to claim 5, wherein a width of the flange coupled to the convex fold may be substantially equal to the width of the retainment tab.

8. The air spring assembly according to claim 1, wherein gaiter further comprises a vertical portion located between the flange and the free end of the gaiter, wherein a diameter of the vertical portion is greater than a diameter of the flange.

9. The air spring assembly according to claim 8, wherein the diameter of the vertical portion is greater than the diameter of the retainment tab.

10. The air spring assembly according to claim 8, wherein the vertical portion extends around the entire circumference of the gaiter.

11. The air spring assembly according to claim 8, wherein the diameter of the vertical portion is equidistant from a longitudinal axis of the gaiter about the entire circumference of the gaiter.

12. The air spring assembly according to claim 1, wherein a diameter of the flange is equidistant from a longitudinal axis of the gaiter about the entire circumference of the gaiter.

13. The air spring assembly according to claim 1, wherein the diameter of the retaining tab is equidistant from a longitudinal access of the guide tube about the entire circumference of the guide tube.
